(19) United States
(12) Patent Application Publication
(10) Pub. No.: US 2008/0098102 A1
(43) Pub. Date: Apr. 24, 2008

(54) System and method for scalable internet helpdesk automation

(76) Inventor: Michael Terrell Vanover, Raleigh, NC (US)

Correspondence Address: ROGITZ & ASSOCIATES, 750 B STREET, SUITE 3120, SAN DIEGO, CA, 92101, US

(21) Appl. No.: 11/585,445

(22) Filed: Oct. 24, 2006

(51) Int. Cl. G06F 15/16; G06F 15/173

(52) U.S. Cl. 709/223; 709/218

(57) ABSTRACT

User computers are enrolled in a management system over the Internet only at such time as a help request is tendered, and once the request is resolved, a user computer is disenrolled, facilitating use of a manageably small help resolution database and reasonable performance from the management system.

### I. FIELD OF THE INVENTION

The present invention relates generally to scalable Internet helpdesks.

### II. BACKGROUND OF THE INVENTION

Computer devices of customers such as very small businesses (VSB) and single consumers are not able to be treated as managed devices for helpdesk purposes because the current interaction model is purely transactional, i.e., single-incident based, and there is no scalable means of extending current systems management solutions (designed for typically regular Intranet relationship to devices) to these systems. Hence, as understood herein problem determination and resolution mechanisms are now limited to significantly more labor intensive tools such as phone, chat and remote console takeover, each of which consumes approximately twenty minutes of personnel time on average per incident.

As also understood herein, typical Internet-based systems management cores are limited to supporting no more than 100,000 managed devices or so. This means that such systems management cores, which can be used to support a team of several thousand helpdesk problem resolvers, cannot adequately address a pool of potentially millions of devices absent the present invention.

### SUMMARY OF THE INVENTION

A standard systems management managed device relationship is established between a device and an Internet help server using Internet brokering when a transactional problem resolution request is received. The device remains a managed device as long as any active problem resolution request is active. Once all desired problems are resolved, the device is completely removed from the systems management database and communication can be terminated, returning the device to a non-managed state and removing all load on the system management core. In this way, a systems management core which may be suitable for no more than managing simultaneously a hundred thousand or so managed devices can be used to support a team of several thousand helpdesk problem resolvers addressing a pool of millions of devices. The transient relationship to the systems management core provides access to a very highly automated set of tools for problem identification, correlation, and resolution useful for dramatically reducing the average time to resolve a problem when compare to current practices.

Accordingly, a system includes at least one user computer and a management system including a database and configured to communicate with the user computer over a wide area network. The user computer is enrolled in the management system as a managed device only at such time as the user computer initiates a help request. The management system resolves the help request, and then the user computer is disenrolled as a managed device until a next help request is issued by the user computer.

In some non-limiting implementations the management system downloads device-side agents to the user computer prior to any help request from the user computer. A device-side agent can execute a scan of assets on the user computer, and in response to a help request from the user computer, results of the scan can be sent to the management system. At this time but not before the user computer is enrolled with the management system as a managed device.

In non-limiting implementations the scan and/or sending the results thereof to the management system may be undertaken by a container that is able to provide both a user interface and to communicate with underlying agents natively. In further non-limiting implementations the user computer appears as a managed device as which user computer becomes subject to scheduled, group, and proactive activities and jobs executed by the management system such that good computer health policies executed by the management system control related practices to be enforced on the user computer without any specific user intervention. A helpdesk computer may be provided and associated with the management system to access scan results in the database to diagnose problems with the user computer and resolve them.

In another aspect, a method for resolving at least one problem with at least one user computer initiating a help request includes bringing the user computer into scope into a management system in response to the help request, and using the management system to resolve the problem. The method also includes causing the user computer to leave the management system until a next problem arises, thereby facilitating use of a relatively small help resolution database and facilitating performance from the management system.

In yet another aspect, an Internet-based management system includes means for enrolling a user computer as a managed device subject to scheduled, group, and proactive activities only in response to a help request from the user computer, and means for disenrolling the user computer as a managed device upon resolution of the help request.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with present principles; and

FIG. 2 is a flow chart of non-limiting logic in accordance with present principles.

### DETAILED DESCRIPTION OF THE PREFERRED EMBODIMENT

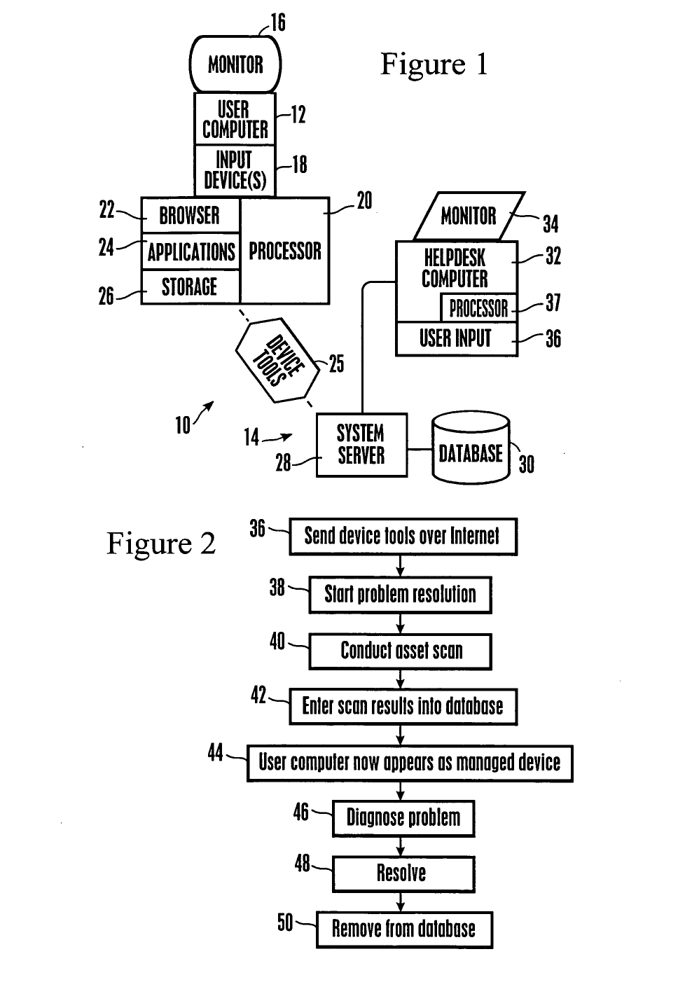

Referring initially to FIG. 1, a system is shown, generally designated 10, which includes plural user computers 12 (only a single user computer shown for clarity) communicating over a wide area network such as the Internet with a management system, generally designated 14. Typically, a user computer 12 includes one or more output devices such as a computer monitor 16 and one or more input devices 18 such as keyboards, mice, voice recognition hardware, etc. Also, each user computer 12 includes a respective processor 20 that can execute software in accordance with logic herein, including a web browser 22 and various software programs and applications 24, including device “agents” 25 downloaded from the management system 14. The software may be stored on a storage 26 such as disk storage and/or solid state memory storage.

The management system 14 typically includes one or more servers 28 that can access a management database 30. The database 30 may be able to simultaneously support only a fraction of the total number of user computers 12 that are desired to be supported, with the logic disclosed herein permitting such a limited system (perhaps able to simultaneously support a few hundred thousand user computers) to nonetheless support a base of millions of user computers 12 over time.

Typically, one or more helpdesk computers 32 communicate with the system server 28 and are operated by trained helpdesk personnel to execute help requests from user computers 12. Each helpdesk computer can include a respective output device such as a monitor 34 and one or more input devices 36 such as keyboards, mice, voice recognition hardware, etc. Also, each helpdesk computer 32 includes a respective processor 37 executing software in accordance with logic herein.

Now turning to FIG. 2, commencing at block 36 all device-side agents 25 that are required for executing the present logic may be pre-installed on the user computer 12 or in response to a help demand or other command from the user computer 12. In one non-limiting preferred implementation, device side agents 25 are pre-installed prior to vending or at least prior to any problems arising and thus can be management enabled.

A web link can be used to download all required agents and to initiate a problem resolution request if on demand installation is required.

At block 38, problem resolution is started, at which point (but not before) the user computer 12 is enrolled into the management database 30 by a device-side agent 25. The agent 25 can conduct a detailed asset scan of the user computer 12 at block 40 (to discover both software and, if desired, hardware possessed by the user computer 12) before or after receiving the problem resolution request at block 38, but in any case the agent sends the results of the scan to the management system 14 automatically in response to a problem resolution request from the user computer 12. This can be accomplished either by a web interface that sends information to the underlying device agent code through a mechanism such as an active-X control or more preferably by a container that is able to provide both the user interface to the problem resolution request process and to communicate with the underlying agents natively.

The device side agent(s) 25 undertaking this process can be supplied with the Internet address of a broker application executed by the management system 14 during the problem resolution request interaction. This address can be used to differentiate between such business related distinctions as service provided by default or services provided by a specific business partner.

In any case, the scan results are stored in the system database 30 at block 42, at which point the user computer 12 appears to the management system 14 as a managed device at block 44. When the user computer 12 appears as a normal managed device at block 44, it becomes subject to all scheduled, group, and proactive activities and jobs. Thus, good health policies executed by the management system 14 can control related practices to be enforced on the newly managed user computer 12 without any specific user intervention if desired.

Also, the helpdesk computer 32 can also either directly drive the system management functions through a typical system management admin interface, or the use of these system management console functions can be related to the helpdesk use through a workflow abstraction that only reveals the appropriate aspects of the system management capabilities when required and only to helpdesk personnel that should have such access. The latter is the preferred implementation.

In any case, the helpdesk computer 32, having access to the database 30 and hence to the scan results of the user computer 12, can diagnose problems with the user computer 12 at block 46 and resolve them at block 48. Once the transactional problem is resolved (and assuming no new problem has been opened) the user computer 12 is notified that the problem is believed to be fixed. If no action is taken by the user of the computer 12 (within a limited period of time) or if the user closes the problem, the user computer 12 is removed from management (as if taken out of an enterprise life cycle) at block 50 by removing from the database 30 information including scan results related to the user computer 12. If the user computer 12 reopens the problem or opens another problem the entire cycle is started again at block 38 with a new problem resolution request and corresponding re-enrollment.

Upon removal from the database 30, device-side agents 25 can either be completely removed from the user computer 12 or more preferably remain dormant for the next use.

Accordingly, unlike a standard enterprise managed device, user computers 12 in accordance with present principles “come into scope” into the management system 14 and get healthy (at least healthier) and then go out “on their own” by leaving the management system 14 until next problem resolution. This allows a manageable database 30 and reasonable performance from the management system 14.

While the particular SYSTEM AND METHOD FOR SCALABLE INTERNET HELPDESK AUTOMATION is herein shown and described in detail, it is to be understood that the subject matter which is encompassed by the present invention is limited only by the claims.

What is claimed is:

1. A system, comprising:
at least one user computer; and
at least one management system including a database and configured to communicate with the user computer over a wide area network;
the user computer being enrolled in the management system as a managed device only at such time as the user computer initiates a help request, the management system resolving the help request, the user computer being disenrolled as a managed device until a next help request is issued by the user computer.

2. The system of claim 1, wherein the management system downloads device-side agents to the user computer prior to any help request from the user computer.

3. The system of claim 2, wherein at least one device-side agent executes a scan of assets on the user computer.

4. The system of claim 3, wherein in response to a help request from the user computer, results of the scan are sent to the management system, at which time but not before the user computer is enrolled with the management system as a managed device.

5. The system of claim 4, wherein the scan and/or sending the results thereof to the management system is undertaken by a container that is able to provide both a user interface and to communicate with underlying agents natively.

6. The system of claim 5, wherein when the user computer appears as a managed device, the user computer becomes subject to scheduled, group, and proactive activities and jobs executed by the management system such that good computer health policies executed by the management system control related practices to be enforced on the user computer without any specific user intervention.

7. The system of claim 6, comprising at least one helpdesk computer associated with the management system and accessing scan results in the database to diagnose problems with the user computer and resolve them.

8. A method for resolving at least one problem with at least one user computer initiating a help request, comprising:
bringing the user computer into scope into a management system in response to the help request;
using the management system, resolving the problem; and
causing the user computer to leave the management system until a next problem arises, thereby facilitating use of a relatively small help resolution database and facilitating performance from the management system.

9. The method of claim 8, the user computer being enrolled in the management system as a managed device only at such time as the user computer initiates a help request, the management system resolving the help request, the user computer being disenrolled as a managed device until a next help request is issued by the user computer.

10. The method of claim 9, wherein the management system downloads device-side agents to the user computer prior to any help request from the user computer.

11. The method of claim 10, wherein at least one device-side agent executes a scan of assets on the user computer.

12. The method of claim 11, wherein in response to a help request input to the user computer, results of the scan are sent to the management system, at which time but not before the user computer is enrolled with the management system as a managed device.

13. The method of claim 12, wherein the scan and/or sending the results thereof to the management system is undertaken by a container that is able to provide both a user interface and to communicate with underlying agents natively.

14. The method of claim 13, wherein when the user computer appears as a managed device, the user computer becomes subject to scheduled, group, and proactive activities and jobs executed by the management system such that good computer health policies executed by the management system control related practices to be enforced on the user computer without any specific user intervention.

15. The method of claim 14, wherein at least one helpdesk computer associated with the management system accesses scan results to diagnose problems with the user computer and resolve them.

16. An Internet-based management system, comprising:
means for enrolling a user computer as a managed device subject to scheduled, group, and proactive activities only in response to a help request from the user computer; and
means for disenrolling the user computer as a managed device upon resolution of the help request.

17. The system of claim 16, wherein the system downloads device-side agents to the user computer to assist in the help request.

18. The system of claim 16, further comprising:
at least one management system database; and
at least one helpdesk computer accessing scan results in the database to diagnose problems with the user computer and resolve them.
